(19) United States
(12) Patent Application Publication
(10) Pub. No.: US 2017/0093111 A1
(43) Pub. Date: Mar. 30, 2017

(54) HIGH POWER LASER WITH CHIRPED PULSE AMPLIFICATION

(71) Applicant: THE SCIENCE AND TECHNOLOGY FACILITIES COUNCIL, Chilton, Didcot, Oxfordshire (GB)

(72) Inventors: Christopher John HOOKER, Didcot, Oxfordshire (GB); Paramel Pattathil RAJEEV, Abingdon, Oxfordshire (GB); Yunxin TANG, Didcot, Oxfordshire (GB)

(21) Appl. No.: 15/126,403

(22) PCT Filed: Mar. 9, 2015
(86) PCT No.: PCT/GB2015/050672

§ 371 Date: Sep. 15, 2016

(30) Foreign Application Priority Data
Mar. 18, 2014 (GB) 1404801.1

(51) Int. Cl. H01S 3/00; H01S 3/23

(52) U.S. Cl. CPC H01S 3/0057; H01S 3/2316

(57) ABSTRACT

A high power laser with chirped pulse amplification to produce extremely high power ultrashort pulses is disclosed. A pulse stretcher and methods of stretching a laser pulse are also disclosed. The pulse stretcher comprises: a first diffraction grating (G1) arranged to receive and disperse a seed laser pulse; transfer optics (CM) arranged to collect the dispersed pulse and direct it to a transmission diffraction grating (G2) which is either the first diffraction grating or a second diffraction grating; the transmission diffraction grating arranged to collimate the collected pulse to a reflector (BM), the reflector arranged such that the pulse is reflected back through the pulse stretcher via the transmission diffraction grating. The pulse stretcher provides better phase noise performance of the output pulse, and therefore a reduction in the noise floor to improve contrast pedestal.

### TECHNICAL FIELD

The present invention relates to a high power laser with chirped pulse amplification to produce extremely high power ultrashort pulses. In particular, the present invention relates to improvements in the pulse stretcher to improve the temporal profile of the ultrashort pulses.

### BACKGROUND

Recent advances in chirped pulse amplification (CPA) have allowed the realisation of extremely high power and high intensity laser pulse generation. Such pulses can have a power density as high as ˜10²² W/cm² through the use of titanium:sapphire (Ti:Sa) amplifiers. Pulse durations can be of the order of 30 fs.

Such ultra-high intensity lasers are a powerful and efficient drive source for accelerating electrons. They also find application in many other areas. However, their use in accelerating electrons is particularly suited to generating high energy electron beams (of the order of GeV), which can be used for generating ultrafast pulses of coherent X-rays. The ultra-high intensity laser pulses can also be used to accelerate protons to generate a high-brightness, collimated multi-MeV proton beam.

The temporal contrast of the laser pulses plays a crucial role in high field laser-matter interactions. Clean laser pulses are required to restrict any destructive pre-plasma dynamics, because excessive pre-pulse intensity can significantly modify, damage or even destroy solid targets due to pre-plasma formation prior to the arrival of the main pulse. Knowledge and control of the temporal contrast is therefore an essential part of using high-intensity lasers. Conventionally, the contrast of the ultra-high intensity pulses has been difficult to measure. Advances have been made in pulse contrast measurement through the development of third order auto-correlators for this purpose. Investigations of temporal contrast for several ultra-high intensity pulsed laser systems show a number of features in the contrast graph.

It is desirable to be able to control contrast features before and after the main pulse so as to be able to repeat the process reproducibly.

U.S. Pat. No. 6,081,543 describes a stretcher-compressor assembly having a single grating. The use of a single grating is described as providing a simplified laser system compared to stretchers having gratings pairs. A paper by Loiseaux et al. “Characterisation of perpendicular chirped phase volume grating pairs for laser pulse stretching”, Optics Letters, Vol. 21, No. 11, June 1996, describes a stretcher which uses chirped gratings.

### SUMMARY OF THE INVENTION

The present invention is directed to improvements in pulse stretchers for high power lasers, such as chirped pulse amplification lasers. The pulse stretcher of the present inventions replaces conventional metal coated diffraction gratings with at least one transmission diffraction grating in the stretcher. Preferably, the transmission diffraction grating is used for the second grating if a pair of gratings is used in the stretcher. The result is significantly improved phase noise performance of the output pulse, and therefore a reduction in the noise floor close to the pulse so as to improve contrast pedestal.

In more detail, the present invention provides a pulse stretcher, comprising: a first diffraction grating arranged to receive and disperse a laser pulse; transfer optics arranged to collect the dispersed pulse and direct it to a transmission diffraction grating; the transmission diffraction grating arranged to collimate the collected pulse towards a reflector, the reflector arranged such that the pulse is reflected back through the pulse stretcher via the transmission diffraction grating. By reflected back we mean that the direction of propagation is substantially reversed, but the return path may be offset from the forward path or diverging slightly from the forward path. The path is reversed through the stretcher, namely through the diffraction grating, transmission diffraction grating and transfer optics. Transfer optics are used to transfer the pattern of divergent light output from a first pass through a diffraction grating to be input as a second pass through a diffraction grating. The first and second passes may be through separate gratings or the same grating, that is the transmission diffraction grating may be the first diffraction grating or a second diffraction grating. The transfer optics may comprise one or more components. The one or more components may be lenses, mirrors or a combination of the two. The pulse stretcher may be for a laser such as a chirped pulse amplification laser.

The laser pulse may be a seed laser pulse generated from, for example, a titanium:sapphire laser and acts as a starting pulse for stretching, amplification and compression to increase the power of the pulse. The laser pulse includes a range of wavelengths, which will usually be a continuum or spread of wavelengths. The diffraction grating diffracts the light different amounts according to its wavelength. Accordingly, the wavelengths leaving the diffraction grating are distributed or spread throughout a range of diverging angles from a point or region on the grating. The wavelengths are divergent and/or spatially dispersed from one another in the angular spread. The transfer optics change the direction of the wavelengths of the pulse diverging from the grating such that the different wavelengths are no longer diverging but directed towards each other, that is, they are converging. The different wavelength components do not converge on a point but reach the transmission diffraction grating before they are able to do so. The transfer optics therefore may be considered to perform a focussing function but do not bring the wavelengths to a focus. The transmission diffraction grating may diffract and align the wavelength components of the pulse. After passing through the transmission diffraction grating the path direction of each of the wavelength components of the pulse are aligned parallel, that is they are collimated. The advantage of a transmission diffraction grating is reduced phase noise compared to a conventional metal coated reflective diffraction grating.

The transmission diffraction grating may be arranged such that wavelengths of the pulse arrive at the transmission diffraction grating over successive times. In other words, there is a temporal spread in the arrival time at the transmission diffraction grating of the various spectral components of the pulse. Those wavelengths arriving earlier further having a shorter path to travel on to the reflector, thereby providing a chirped pulse. By positive chirp we mean that the higher frequency is delayed.

The transfer optics may be arranged to collect and direct the divergent wavelengths of the dispersed pulse so as to bring the wavelengths onto convergent paths. The transmission grating may be arranged on said convergent paths preventing convergence to focal point. It may be considered that a virtual image is formed behind the transmission diffraction grating.

The transmission diffraction grating may collimate the wavelengths in a direction normal to the reflector. The reflector may be a plane mirror or a roof mirror. A roof mirror comprises two plane mirrors arranged with their reflecting surfaces at right angles to each other. The reflector may be positioned at the opposite side of the transmission diffraction grating to the transfer optics.

The transfer optics, transmission diffraction grating and reflector may be arranged such that for a first wavelength of the laser pulse the path length from transfer optics through transmission diffraction grating to reflector is different to that for a second wavelength of the laser pulse. The path length of the first wavelength of the laser pulse from transfer optics through transmission diffraction grating to reflector may be greater than the path length of a second wavelength of the laser pulse from the transfer optics through transmission diffraction grating to reflector, wherein the first wavelength is less than the second wavelength, the pulse stretcher thereby imparting a positive chirp to the pulse. For CPA applications it is preferred to induce positive chirp on the stretched pulse.

The path length difference between the first wavelength and the second wavelength may be of the order of tens of centimetres. Frequencies corresponding to the first wavelength and the second wavelength may be the frequencies at the upper and lower FWHM points of the pulse. The frequencies may be frequencies of light from approximately 300 THz to approximately 450 THz, or equivalent to wavelengths in the 700-900 nm range.

In embodiments of the present invention the pulse stretcher may comprise one or two diffraction gratings.

For a two diffraction grating stretcher, the diffraction grating arranged to receive and spatially disperse wavelengths of a laser pulse such that the wavelengths are divergent from one another is a first diffraction grating, and the transmission diffraction grating is a second diffraction grating spaced apart from the first diffraction grating.

The path length from first diffraction grating to transfer optics may be greater than the path length from transfer optics to second diffraction grating. The distance from transfer optics to second diffraction grating may be less than the distance from transfer optics to first diffraction grating.

The first diffraction grating may also be a transmission diffraction grating.

The first diffraction grating preferably has substantially equal line density to the second diffraction grating. The line densities are substantially uniform across the whole of the active area or lined area of the grating.

The reflector may reverse the path of the pulse such that a pulse having traversed the stretcher firstly in a forward direction subsequently traverses the stretcher in a reverse direction, such that the pulse is incident on each grating in the stretcher twice.

In one embodiment of the present invention the transfer optics comprises a concavely curved mirror. In this embodiment, in combination with the reflector, the paths undergo reflection three times only.

The concavely curved mirror may be spherically curved.

The concavely curved mirror may have a radius of curvature R. The first diffraction grating may be positioned at a distance R from the curved mirror. The distance R may be greater than radius of curvature of the curved mirror. The second diffraction grating may be positioned at a distance less than R from the curved mirror. The second diffraction grating may be positioned parallel to the first diffraction grating.

The point and/or line of incidence on first diffraction grating and second diffraction grating are arranged on opposing sides of a plane comprising the centre of curvature of the curved mirror and the line at which diffracted light is incident on the curved mirror.

In another embodiment of the present invention the transfer optics comprises two converging lenses, for example in a transmission grating based Martinez stretcher configuration.

A first of the two converging lenses may be arranged such that its focal plane is at the first diffraction grating. The second of the two lenses may be arranged in a telescope arrangement with the first lens and may be at a distance less than the focal length of the second lens from the second diffraction grating. By telescope configuration we mean that the centres of the lenses are spaced apart by the sum of their focal lengths.

The centres of the first and second lenses may be spaced apart by the sum of their focal lengths.

In a further embodiment of the present invention the transfer optics comprises two converging lenses and a diverging lens, for example in a transmission grating based lens Öffner stretcher configuration.

A first of the two converging lenses may be arranged such that its focal plane is at the midpoint between the first diffraction grating and the first converging lens. The centres of the first and second lenses may be spaced apart by the sum of their focal lengths, and the diverging lens may be at the focal plane of the first and second lenses.

In a yet further embodiment of the present invention the stretcher comprises a diffraction grating and the transfer optics comprises a concave mirror and a convex mirror, for example in a transmission grating based reflective mirror Öffner stretcher configuration.

The single diffraction grating is a transmission diffraction grating arranged to receive and spatially disperse wavelengths of a laser pulse such that the wavelengths are divergent from one another, said transmission diffraction grating may also arranged to collimate the collected pulse towards a reflector.

The concave mirror may be a spherically curved mirror and may have a radius of curvature R. The convex mirror may be spherically curved. The concave mirror and convex mirror may have a common centre of curvature. The convex mirror may have a radius of curvature of R/2 and may be arranged at a distance of R/2 from the concave mirror. The diffraction grating may be arranged at distance less than R from the concave mirror.

The reflector reverses the path of the pulse such that in combination with the concave and convex mirrors, the pulse may traverse the grating twice in a forward direction and twice in a reverse direction, such that the pulse may be incident on the grating in the stretcher four times.

In embodiments of the present invention the stretcher may be arranged to stretch the duration of the pulse by a factor of at least 500, and preferably more than 1000 times. By duration of the pulse we mean, for example, the FWHM duration.

The stretcher may comprise an input device for directing the laser pulse at the diffraction grating at the Littrow angle. The Littrow angle is the angle of incidence at the grating at which said angle of incidence is equal to the angle of the transmitted diffracted light for the central wavelength.

The seed laser pulses may have durations in the order of picoseconds and energy in the order of millijoules. For example, the duration may be in the range from 1 to 100 picoseconds and energy in the range from 0.1 to 10 millijoules.

The pulse stretcher may be configured as part of a laser comprising an oscillator for generating seed laser pulses.

The present invention also provides a laser comprising the stretcher set out above. The laser may be a chirped pulse amplification laser, comprising: an oscillator for generating seed pulses; the pulse stretcher as set out above; at least one amplifier for increasing the energy of the stretched pulses; and a pulse compressor for temporally compressing the amplified pulses.

The compressor may comprise reflective diffraction gratings, and the transmission diffraction grating of the stretcher may have an orthogonal polarisation compared to the reflective diffraction gratings of the compressor.

The amplified pulses output from the compressor may have durations in the order of femtoseconds such as in the range 1 to 100 femtoseconds, and peak power in the order of hundreds of terawatts to petawatts.

The transmission diffraction grating may be uncoated so that spectral phase noise induced by said transmission diffraction grating is less than that of an equivalent reflective metal coated grating, i.e. one having the same line density, thereby improving the contrast pedestal of the output amplified pulse. The plane surface of the grating, that is the surface without grooves, may have an anti-reflection coating.

The present invention provides a method of stretching a pulse such as for a chirped pulse amplification laser, the method comprising: receiving and spatially dispersing wavelengths of a laser pulse such that the wavelengths are divergent from one another, such as using a first diffraction grating; collecting the divergent wavelengths and directing them towards a transmission diffraction grating which is either the first diffraction grating or a second diffraction grating; the transmission diffraction grating collimating the collected wavelengths towards a reflector, and back reflecting the collimated wavelengths to the transmission diffraction grating reversing the direction of the path of the pulse through the stretcher.

The diffraction gratings of the pulse stretcher are preferably arranged to cause the higher frequency components (shorter wavelength) to travel a longer path than the lower frequency components (longer wavelength). This means the higher frequency components are temporally delayed compared to the lower frequency components. The pulse compressor delays the lower frequency components so as to bring the high and low frequency components more into temporal alignment, that is, temporally coincident, so as to provide high peak intensity.

### BRIEF DESCRIPTION OF THE DRAWINGS

Embodiments of the present invention and aspects of the prior art will now be described with reference to the accompanying drawings, of which:

FIG. 1 is a schematic diagram of a high power chirped pulse amplification (CPA) laser system, including stretcher, amplifiers and compressor;

FIG. 2 is a graph showing the typical temporal profile of an ultra-intense laser pulse such as produced by the laser of FIG. 1;

FIG. 3 is a graph showing pulse temporal profile measured results for a laser system based on titanium-sapphire;

FIG. 4 is a diagram showing an alternative configuration for a stretcher which has been used with the Astra-Gemini laser at the Rutherford Appleton Laboratory;

FIG. 5 is schematic diagram of an experimental arrangement for measuring the performance of a transmission diffraction grating using a non-stretching geometry;

FIG. 6 is graph comparing temporal profiles of a single transmission diffraction grating with a single reflective diffraction grating in a non-stretching configuration;

FIG. 7 is a schematic diagram of a transmission grating based stretcher incorporated into a CPA laser system;

FIG. 8 is graph showing calculated spectral phase error due to the grating line density mismatch in the arrangement of FIG. 7;

FIG. 9 is a combined graph and contour plot showing intensity and phase variation of the stretched and compressed pulse measured using a FROG instrument;

FIG. 10 is a graph showing the temporal intensity profile of the transmissive and reflective diffraction gratings;

FIG. 11 is a schematic diagram of a stretcher design by Martinez et al.;

FIG. 12 is a schematic diagram of a stretcher design based on the reflective grating stretcher of FIG. 11 but using transmission reflective gratings;

FIG. 13 is a schematic diagram of a stretcher design based on a mirror Öffner stretcher but using transmission reflective gratings; and

FIG. 14 is a schematic diagram of a stretcher design based on a lens Öffner stretcher but using transmission reflective gratings.

### DETAILED DESCRIPTION

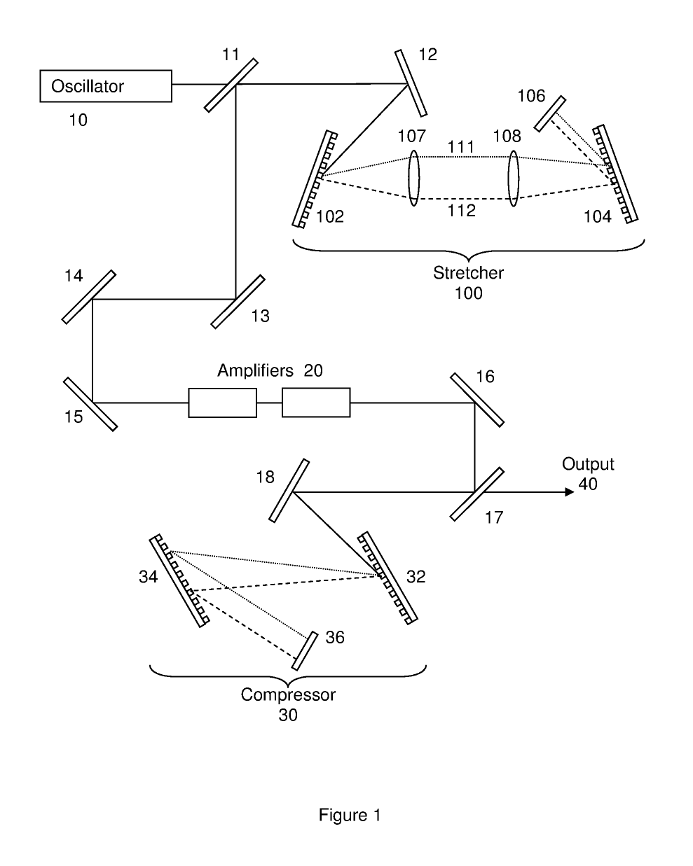

FIG. 1 is a schematic diagram of a high power chirped pulse amplification (CPA) laser system. The system consists of an oscillator 10, a pulse stretcher 100, an amplifier or multiple amplifiers 20 in a chain and a compressor 30. The oscillator provides a series of seed pulses for amplification. In the example of FIG. 1 the pulses are directed past mirror 11 and reflected at mirror 12 towards the stretcher 100. The mirror 11 is of limited size and at first pass from the oscillator to mirror 12, the pulses pass above or to the side of mirror 11 bypassing it. Alternatively, the mirror 11 may be a partially reflecting mirror such as a semi-silvered mirror. The stretcher comprises a pair of diffraction gratings 102 and 104, a pair of lenses 107 and 108, and back mirror 106. Mirror 12 directs the pulses at the first diffraction grating 102. The diffraction grating diffracts the input pulse according to their wavelength spreading the pulse such that the different wavelengths diverge from the point of incidence on the grating 102. The dotted line 111 represents a low frequency, long wavelength component of the pulse, whereas the dashed line 112 represents a high frequency, short wavelength component of the pulse. The low and high frequency components are diffracted and reflected such that they exit the grating 102 towards the normal of the grating, but the high frequency component is diffracted further and exits the grating at an angle closer to the normal of the grating than the low frequency component. The low and high frequency components may represent the frequencies at the full width half maximum (FWHM) frequencies. A range of frequencies between and outside these frequencies may also be present. The diverging components of the pulse arrive at lens 107 which collimates the different wavelength components of the pulse such that all components of the pulse are travelling on parallel paths. In some embodiments strict collimation may not be achieved but the degree of divergence of the different components is nevertheless reduced after lens 107. Lens 108 brings the paths of the various frequencies towards convergence. The lenses 107 and 108 are arranged in a telescope configuration. The first diffraction grating 102 is planar having a normal which is not parallel, but offset by an angle, to the axis of lenses 107 and 108. The second diffraction grating 104 is positioned closer to the lens 108 than the focal length of the lens such that the converging components of the pulse meet the second diffraction grating 104 preventing them converging to a point. The second diffraction grating 104 has the same line density as the first diffraction grating 102 and is also arranged not parallel, but offset by an angle, to the axis of lenses 107 and 108. The second diffraction grating diffracts the components of the pulse by equal but opposite amounts as the first diffraction grating. This results in the various different constituent wavelengths travelling on parallel paths to back mirror 106. Correct alignment of the two gratings with respect to one another is required for achieving the best performance. The plane of the image of the first grating formed by the transfer optics should be substantially parallel to the second grating, and the grooves of the two gratings should also be substantially parallel to one another. This condition can be achieved by the use of a broadband laser source, for example the seed pulse that is being stretched, or by the use of two different continuous-wave lasers whose beams are arranged to be coincident and parallel to one another. The beam at the output of the stretcher is examined, and the gratings are adjusted using the movements on their respective mountings until the spot from the broadband source is considered not to be elongated in any direction, or until the spots of the two different wavelengths are coincident.

Back mirror 106 is a plane mirror and reflects the constituent wavelengths and reverses their paths. The constituent wavelengths travel in reverse back through the stretcher along the same path as they did to arrive at the back mirror 106. In a preferred arrangement, the back mirror may be tilted up or down (about an axis in the plane of the stretcher) such that the return path is slightly offset by from the forward path. This offset moves the pulse up and down the lines of the grating but does not change the diffracted angle of the pulse. The back mirror 106 is arranged at an angle to the optical axis of lenses 107 and 108 such that the path lengths travelled by the constituent wavelength parts of the pulse are not the same. The low frequency, long wavelengths (represented by dotted line 111) arrive at the second diffraction grating at a position closer to the back mirror than the high frequency, short wavelength components. They also have a shorter distance to travel to the back mirror. As a result the low frequency, long wavelengths travel a shorter distance in the stretcher than the high frequency, short wavelengths. This results in the high frequency, short wavelength components being delayed compared to the low frequency, long wavelength components. In other words the pulse becomes positively chirped. On the return path through the stretcher the delay is doubled increasing the positive chirp.

After leaving the stretcher the pulse is reflected by mirror 12. Since the angular offset of the back mirror has moved the pulses up or down, the pulses are now reflected by mirror 11 towards mirrors 13, 14 and 15 which direct the beam towards amplifiers 20. Mirrors 13, 14 and 15 are not essential but are used for convenience to fold the optics. For example, by folding the optics the footprint of the laser may be reduced or arranged to fit in a desired space, such as on an optical table.

After passing through mirrors 13, 14 and 15 the pulses arrive at amplifier chain 20. Alternatively a single amplifier may be used. The amplifiers increase the energy of the pulse. Non-linear effects in the amplifiers are avoided because the pulse has been stretched reducing its peak power and temporally distributing the various frequency components of the pulse.

Mirrors 16, 17 and 18 are also provided for convenience to fold the path and reduce the footprint of the laser. The pulses are directed sequentially through mirrors 16, 17 and 18 towards the compressor. Mirror 17 may be a semi-silvered mirror, or more preferably on the return path the pulses bypass the mirror. At the compressor 30 the pulses first arrive at diffraction grating 32. The pulse is reflected and diffracted such that the low frequency components of the pulse exit the diffraction grating 32 further away from the normal than the high frequency components of the pulse, as shown by the dotted and dashed lines in FIG. 1. The diffraction grating 32 distributes the frequencies of the pulse across the second diffraction grating 34 of the compressor. The pulse is further diffracted at diffraction grating 34 towards back mirror 36 of the compressor. The back mirror is a plane mirror. The low frequency components have to travel further from the grating 34 to the back mirror. This is because the low frequency components were diffracted further away from the normal of the first grating than the high frequency components. The longer path travelled by the low frequency components of the pulse results in those components being delayed in comparison to the high frequency components. The back mirror reverses the path of the components of the pulse such that they follow a reverse path through the compressor 30 and via mirror 18. Similar to back mirror 106 of stretcher, back mirror 36 of compressor may have an angular offset to move the pulses up or down the diffraction gratings. The delay of the low frequency components is doubled as they return from back mirror 36 through compressor 30 towards mirrors 18 and 17. The displacement of the back mirror 36 means that the pulses bypass mirror 16 such that the pulses are not returned to the amplifiers 20 but are now output 40 from the laser. Alternatively, the back mirror 36 may not have an angular offset and the mirror 17 may be a semi-silvered mirror through which the pulses pass on their return.

The effect of the stretcher 100 is to increase the duration of the pulse and thereby stretch out its energy density in order to avoid non-linear effects in the amplifier chain 20. After the stretched pulses have passed through the amplifier chain the pulses are directed to compressor 30 which compresses the pulses. The longer path traversed by the high frequency components of the pulse in the stretcher resulting in their delay compared to the low frequency components, is counteracted by the shorter path taken by the high frequency components in the compressor. Hence, the high frequency components catch up with low frequency components, effectively reversing the stretching of the pulses performed by stretcher 100. The various frequencies of the pulse become much more temporally coincident as they were after leaving the oscillator.

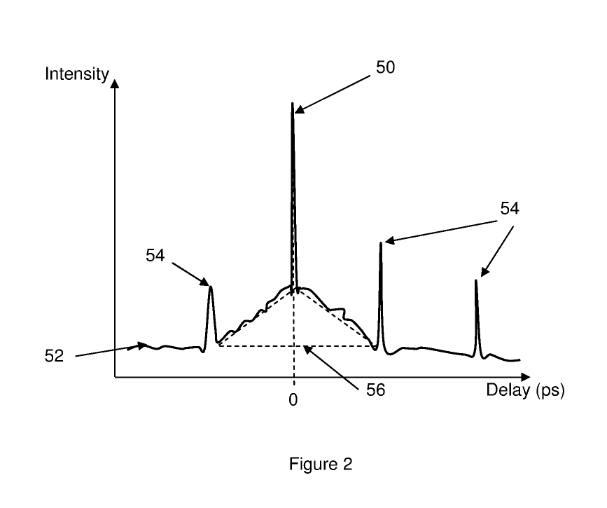

FIG. 2 shows the typical temporal profile of an ultra-intense laser pulse such as produced by the laser of FIG. 1. The main peak of the pulse is shown at 50. The temporal profile comprises three major features: 1) a platform of amplified spontaneous emission (ASE) 52 extending over many nanoseconds; 2) discrete replica pre and post-pulses 54 in the range of a few tens to hundreds of picoseconds; and 3) uncompressed energy within the stretched pulse, which appears as a triangular pedestal shape within ˜5-20 picoseconds of the main pulse. The latter is often referred to as the contrast pedestal (CP). The contrast pedestal reduces the contrast of the main pulse. It is the contrast pedestal that limits control of pulse dynamics immediately before the main pulse and can result in the effects set out above, such as destructive pre-plasma dynamics sufficient to destroy targets.

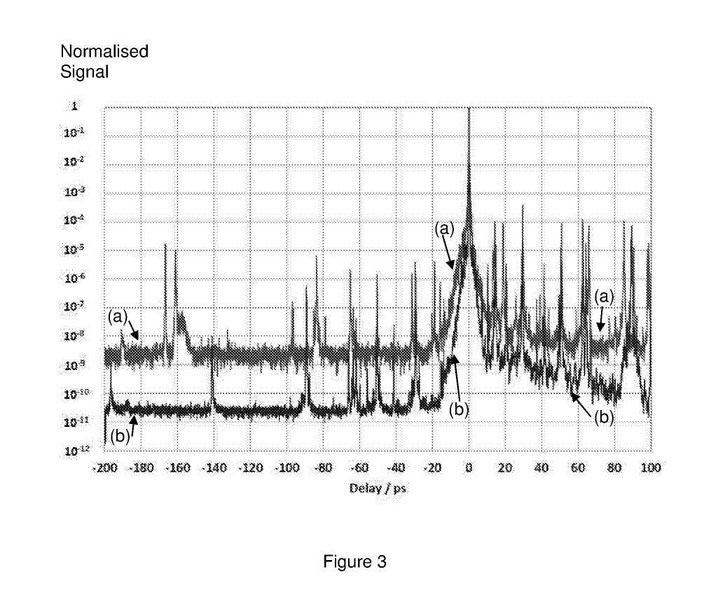

FIG. 3 shows temporal profile measured results for a laser system based on titanium-sapphire. The actual laser system which the results are derived from is the Astra-Gemini laser at the Rutherford Appleton Laboratory in the UK. Corresponding features are seen in results from other ultra-high power lasers from around the world. Astra-Gemini is a laser system of which Astra is a 20 TW chirped pulse amplification (CPA) laser. Gemini is an additional power amplification stage in which the output from Astra is split and amplified to yield two synchronised 0.5 PW pulses. FIG. 3 shows two sets of results. The line marked (a) is the temporal profile measured in 2010 before a number of changes were made. The line marked (b) is the temporal profile measured in 2012 after the changes were made. In the results the ASE baseline can be seen at around 10⁻⁹ below the peak level for the 2010 results and 10⁻¹⁰ for the 2012 results. Pre and post pulses can be seen, and the contrast pedestal can also be seen. The post-pulses are generated by internal reflections in optical components in the laser chain resulting in frequency mixing through non-linear processes associated with the B-integral. The pre-pulses are converted from counterpart post-pulses. Between the times of measuring the temporal profile in curves (a) and (b) various pulse cleaning techniques have been implemented to minimise or remove pre and post-pulses and reduce the ASE background level. Optical windows and the Ti-sapphire crystal have been replaced with wedged equivalents to reduce internal reflections. Optical components have had improved anti-reflective coatings. The Pockels cell for pulse selection has an improved extinction ratio. A better spatial filter has been used. As can be seen from the curves (a) and (b) the overall contrast has been improved in regard to pre-pulses and ASE background level. The contrast pedestal close to the main peak is largely unchanged.

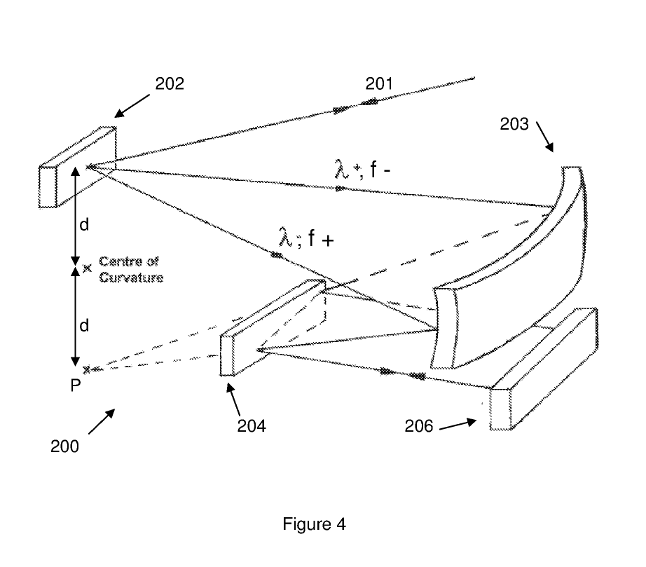

An alternative configuration for the stretcher to that shown in FIG. 1 has been used with the Astra-Gemini laser. This configuration is shown in FIG. 4. We will now discuss this alternative configuration before we describe improvements to reduce the contrast pedestal.

The stretcher 200 of FIG. 4 comprises a pair of reflective diffraction gratings 202, 204, a curved mirror 203 and a back mirror 206. The curved mirror is preferably a concavely curved mirror having a reflecting surface forming part of a sphere. Back mirror 206 is a plane mirror. The diffraction gratings are gold coated reflective gratings. The incident pulse 201 hits the first diffraction grating 202. The pulse is diffracted such that the different frequency components of the pulse exit the diffraction grating at different angles. The low frequency f− (longer wavelength, λ₊) components exit the grating closer to the incidence angle than the high frequency f₊ (shorter wavelength λ−) components. The distributed frequencies are next incident on the spherical mirror 203. The spherical mirror is arranged such that its centre of curvature is in the same plane as the first diffraction grating but offset from the centre of the grating by a distance d. This offset produces an angular offset which directs the distributed pulse to a point P in the same plane as the first diffraction grating but offset from the centre of curvature of the spherical mirror the same distance d as the grating is offset from the centre of curvature. The incidence point on the grating, centre of curvature, and the point P to which the reflected pulse is directed are on a straight line. The curvature of the mirror 203 converges the components of the pulse towards point P. However, before the components of the pulse reach point P they are incident on the second diffraction grating 204. After reaching diffraction grating 204, the components of the pulse are diffracted and reflected towards back mirror 206. The different frequency components of the pulse exit the grating 204 collimated. The components are incident on the back mirror normal to its surface and are therefore back reflected along the direction from which they arrived. The component parts travel the same path from back mirror 206 to first grating 202 as they did towards the back mirror but in in reverse. The stretched pulse is output at 201.

The path length from spherical mirror 203 to second grating 204 to back mirror 206 differs for the high frequency and low frequency components. The second grating 204 is parallel to the first grating 202. The low frequency components have a shorter distance to travel from the spherical mirror 203 to the second diffraction grating 204. The back mirror 206 may not be parallel to second grating 204, such that the low frequency components have a shorter distance to travel than the high frequency components.

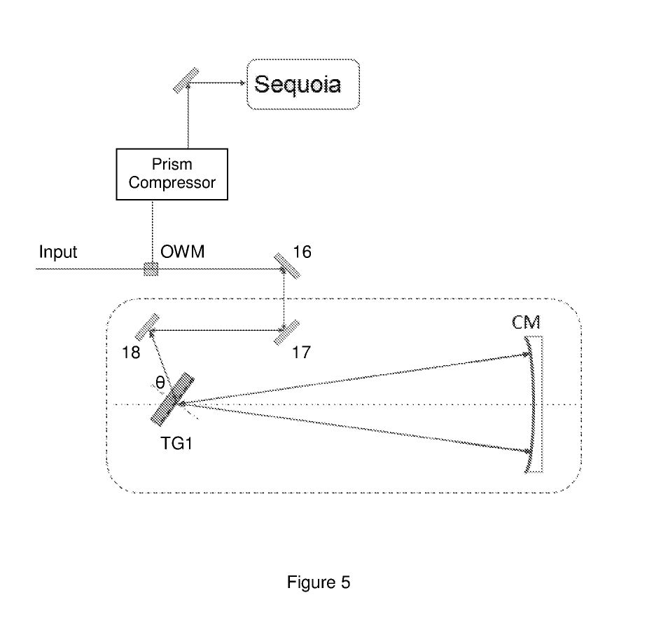

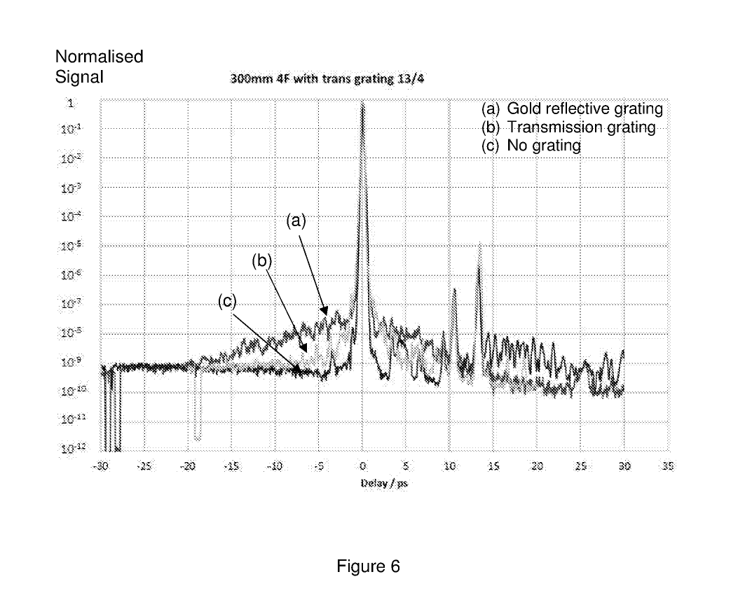

The effect on the contrast pedestal of the first reflective gold grating 202 in stretcher 200 was investigated in a non-stretching geometry. Following this the performance of a transmission diffraction grating was examined in a similar way also using a non-stretching geometry, such as shown in FIG. 5. An unstretched light pulse, after passing through a one-way mirror OWM and via some routing mirrors 16, 17, 18, is incident on transmission grating TG1. The grating is arranged such that its normal has an angular offset to the incident pulse. Preferably the transmission grating is arranged such that the input pulse is incident at an angle θ to the normal, and the central wavelength of the pulse is diffracted and exits the gratings also at an angle θ to the normal. This input angle is known as the Littrow angle. The transmission grating is positioned at the radius centre of curved mirror CM, with the position the light pulse leaves the grating being at the radius centre. The light pulse passes through the grating TG1 and is spatially dispersed as it leaves the grating such that the different frequency components are distributed across the curved mirror. The curved mirror CM retro-reflects the pulse to the same points on the grating as it exited the grating on its path to the curved mirror. The input and output beams on the transmission grating are conjugate images with respect to each other. Individual wavelengths therefore propagate exactly the same return path from mirror and through the grating as they did in the forward path. As a result no stretching of the pulse occurs. The returned pulse passes via routing mirrors 18, 17, 16 and is directed towards a pair of prisms for compression to a near transform limited ultra-short pulse. The temporal contrast is measured by a third order auto-correlator, such as Sequoia from Amplitude Technologies of France. FIG. 6 shows the temporal contrast profile of the resulting pulse, which is compared with a similar profile achieved with a reflective gold diffraction grating using a similar arrangement. The line (b) is the temporal profile for the transmission grating, whereas the line (a) is for the reflective gold grating. A third line (c) is the temporal profile of the input pulse, that is, with no grating present. As can be seen from the figure, the contrast pedestal starts at similar ASE background levels for both gratings. However, the contrast pedestal for the transmission grating is much narrower and smaller. These results suggest an improvement in the contrast pedestal may be obtained by replacing reflective gratings in the stretcher with transmission gratings.

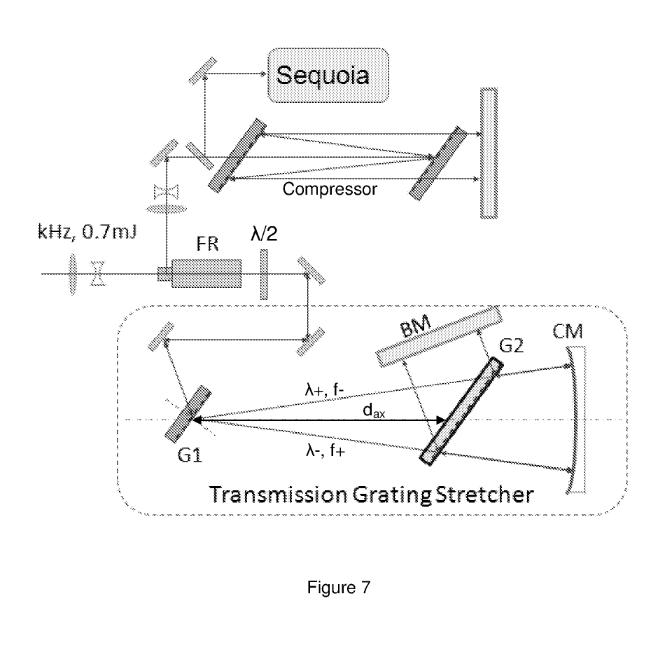

FIG. 7 shows a transmission grating based stretcher incorporated into a CPA laser system which has been modified to test the performance of the stretcher. A seed beam such as generated from a Ti:Sa laser is passed through a fast Pockels cell to produce unstretched laser pulses. The pulses have an energy of ˜0.7 mJ and a pulse width of ˜7 ps. The repetition rate is 1 kHz. The laser pulses are injected through a Faraday Rotator (FR) type isolator towards a half-wave plate (λ/2). The half-wave plate in combination with the Faraday rotator rotates the plane of light by 90°. On the return path the combined rotations of the Faraday rotator and half-wave plate cancel out so the light is rejected at the polarizer as will be discussed below. On the input path after passing through the half-wave plate the pulses are directed to a series of mirrors. The series of mirrors route the pulses towards the stretcher.

The stretcher itself is based on the reflective grating stretcher of FIG. 4, but the reflective gratings are replaced by transmission gratings G1, G2. We now describe the stretcher of FIG. 7. The stretcher comprises a pair of transmission diffraction gratings G1, G2, a curved mirror CM, and a back mirror BM. Similarly to the stretcher of FIG. 4 the first grating is positioned at a distance from the curved mirror equal to the radius of curvature of the curved mirror. The curved mirror is preferably a spherically curved mirror. Second diffraction grating G2 is positioned at a distance between the curved mirror and first grating but offset from the axis between the first grating G1 and curved mirror CM. Back mirror BM is a plane mirror and is positioned behind the second transmission grating. Alternatively a roof mirror comprising a pair of plane mirrors arranged at 90° to each other may be used. The pulses propagate along the path from first grating G1 to curved mirror CM to second grating G2 to back mirror BM. G2 is positioned parallel to G1. At the back mirror the pulses are back reflected along the same path but in reverse. In more detail the pulses arrive at the first transmission grating G1 and are diffracted such that the various frequencies/wavelengths forming the pulse spatially diverge as they exit the transmission grating. The angle from the normal at which each wavelength exits the grating increases with wavelength. The grating G1 is arranged at an angle such that the full range of frequencies from the pulse is distributed across the curved mirror CM. Similarly to FIG. 4 the curved mirror is arranged such that the centre of curvature is offset from the point of incidence of the pulses on the first diffraction grating. The centre of curvature and point of incidence on first grating may be offset such that the centre of curvature is above or below the plane of FIG. 7.

The spatially distributed frequencies are reflected from the curved mirror such that they are on a convergent path. The point of convergence would be the same distance from the centre of curvature as the point at which the pulses are incident on first grating G1. The distributed frequencies do not converge but are incident on second transmission diffraction grating G2 before they reach convergence. The second diffraction grating G2 is also angled to the incident frequencies, but on exiting the transmission grating the various frequencies become collimated, that is they are travelling on parallel paths. The collimated frequencies are incident normal to the back mirror. The reflected frequencies therefore return along the same path as that they arrived at the back mirror.

As shown in FIG. 7 the low frequency, long wavelength components are diffracted more than the high frequency, short wavelength components. Upon reflection from the curved mirror the low frequency components have a shorter distance to travel to the second grating than the high frequency components, because the second grating is at an angle to the curved mirror. From the second grating to the back mirror again the low frequency components have a shorter distance to travel compared to the high frequency components. The high frequency components are therefore temporally delayed compared to the low frequency components. The path differences are repeated on the return path from the back mirror doubling the temporal delay.

The return path sees the spatially distributed frequency components travel back from the back mirror via the second grating G2, curved mirror CM to first grating G1. The spatially distributed frequency components spatially reconverge back to a single pulse as they exit the first grating. The pulse is reconverged but with high frequency components delayed with respect to the low frequency components. This delay forms the stretch to the pulse. After leaving grating G1 the pulse returns via routing mirrors towards the half-wave plate and Faraday rotator FR. In a CPA laser system such as in FIG. 1, the transmission grating stretcher would replace stretcher 100.

In FIG. 7, the Faraday rotator acts as an optical isolator, and comprises offset polarisers at either end of the Faraday rotator. The return beam does not pass all the way through the isolator but is rejected and separated from the input beam at the exit port of the polarizer at the entrance of the optical isolator due to having orthogonal polarisation to the input beam and transmission orientation of the polarizer.

After leaving the isolator the stretched laser pulse is spatially expanded and collimated by a telescope of a pair of lenses to a larger beam size, and then sent into a gold gratings compressor. If the arrangement of FIG. 7 was preferred to be used as a CPA laser system, amplifiers would be included between the Faraday rotator and compressor.

Contrary to conventional reflective gratings, the transmission gratings have TE polarisation orientation for optimum diffraction efficiency. This means the stretcher may be arranged in the in-plane configuration while the compressor is arranged in the out-of-plane geometry, such that the polarisation orientations of stretcher and compressor are orthogonal to each other. This configuration conveniently matches the polarisation orientations set by the polarizer at the entrance of isolator FR, without requiring additional polarization rotation components between the transmission grating stretcher and reflective grating compressor.

The stretched pulse is re-compressed down to the near transform limit by the compressor. A Dazzler or acousto-optic programmable dispersive filter (AOPDF) can also be used, especially in test configurations, to compensate for residual high order phase errors. For the contrast measurement the compressed laser pulse is then injected into a 3rd order auto-correlator, such as the Sequoia in FIG. 7. Removal of the Sequoia and addition of amplifiers would convert the arrangement of FIG. 7 from a test arrangement to a CPA laser with higher power pulses output at the position the Sequoia is removed.

The whole arrangement in FIG. 7 is completely passive with an overall throughput of <40%. For the measurement the compressed laser pulse is spatially demagnified by a factor of ˜3 by a reflective telescope before being injected into the 3rd order auto-correlator. This increases the intensity the auto-correlator can accommodate and it makes it possible to obtain the third harmonic signal required for the contrast measurement of high dynamic range to >109.

### Experiment

The transmission grating based stretcher was implemented with the Astra-Gemini laser mentioned above. A transmission grating having a groove line density of 1480 lines/mm was used, as this is the same line density as for the reflective gold grating which it replaces.

The transmission gratings were positioned at the Littrow angle at the pulse central wavelength of 800 nm. The first transmission grating was placed at a distance from the curved mirror equal to the radius of curvature, but offset slightly from the radius centre. The second grating G2 is separated from the first grating G1 at an axial distance dₐₓ (FIG. 7) of ˜250 mm. The distances to the edges of the used area of the second grating are more and less than from the on-axis point used for dₐₓ, and are ˜298 mm and ˜202 mm. This grating separation gives a stretched pulse length of ˜160 ps for a spectral bandwidth of ˜35 nm FWHM needed to support a short pulse of <30 fs. The transmission grating stretcher is smaller than the full size reflective grating stretcher of Astra-Gemini laser. The full size reflective grating stretcher provides a stretched pulse length of ˜520 ps per pass. The relatively smaller stretching factor of transmission grating stretcher is currently limited by the size of the second transmission grating in the stretcher with respect to the spectral bandwidth concerned. The dimensions of the active area of the second transmission grating are 70 mm×10 mm, which is currently the largest non-custom-made transmission grating commercially available. Nevertheless larger transmission gratings are being developed for increased pulse stretching.

The compressor comprises conventional reflective gold gratings. The line density of the reflective gold gratings in the compressor is 1500 lines/mm that results in a small line density mismatch of 20 lines/mm from the stretcher gratings. Ideally the reflective gratings of the compressor and transmission gratings of the stretcher would have equal line densities, but the current lack of suitable easily available transmission gratings results in this small mismatch.

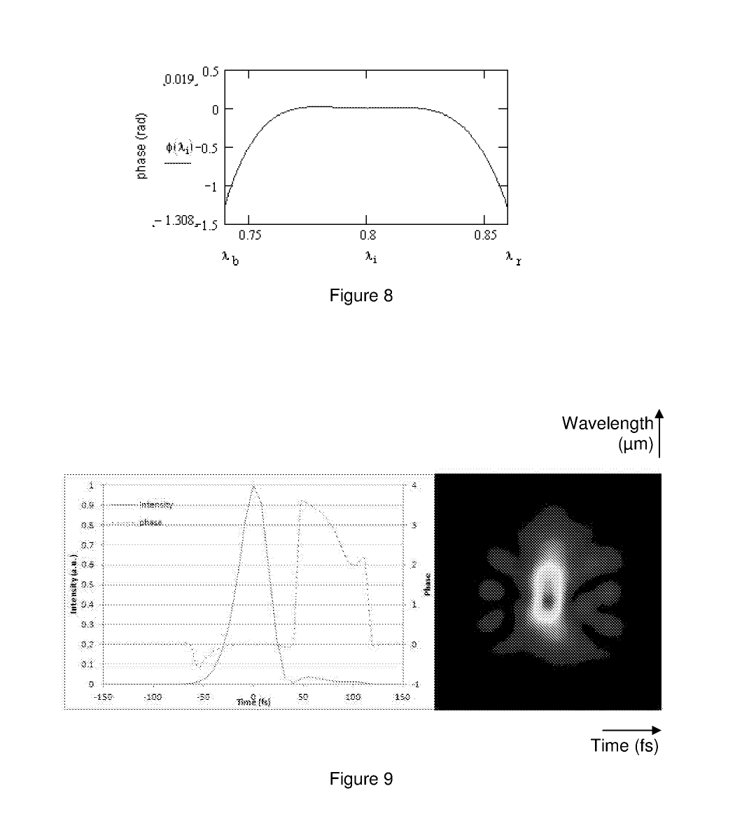

A detailed calculation was undertaken to evaluate the compressibility of the stretched pulse in the presence of grating line density mismatch. For instance, assuming that the non-dispersive incident angle for both stretcher and compressor is ˜5.5°, the transmission gratings in the stretcher were set-up at the Littrow angle of 36.494° and separated by a nominal distance of ˜202 mm. This gives a stretched pulse length of ˜160 ps in line with the above. If the incident angle into the compressor is adjusted to be 37.923°, compared with the normal Littrow angle of 37.069°, with a nominal grating separation of 198.7 mm, the calculated spectral phase error due to the grating line density mismatch alone was found to be small as shown in FIG. 8. The group velocity dispersion GVD and third order dispersion TOD are also close to zero, and fourth order dispersion is small at ˜4×10⁴ fs⁴. The result of the calculation indicates that any high order phase error introduced by a small line density mismatch is negligible when the beam incident angle into the compressor is increased slightly with a corresponding smaller separation. Hence, the stretched pulse can be compressed to a near transform limit short pulse within the spectral bandwidth concerned, even in the presence of a small grating line density mismatch.

In order to minimise aberration and hence the additional phase error introduced by the optics in the stretcher, the beam size into the stretcher was kept relatively small in the range of a fraction of millimetre. Since the focal length of the curved mirror in the stretcher is relatively short at 375 mm (for a spherical mirror this is half of the 750 mm radius of curvature) and the separation (˜250 mm) of the two gratings is approximately one third of the curved mirror radius, care has to be taken to maintain a good match between the input laser beam spatial profile and the cavity spatial mode. The input beam is carefully reshaped and reformatted to produce an optimum beam size on the first grating. The output beam is carefully maintained to be an almost ideal −1:1 conjugate image of the input beam on the first grating to minimise aberration and phase error induced when the stretcher was set-up. The gratings in both the stretcher and compressor were carefully aligned and optimised by monitoring the far field image. To be specific, the grating parallelism in the main dispersion direction and in the groove orientation direction were optimised by precisely overlapping 2 individual far field images of the laser pulse spectrum wings (blue and red) while the central spectral section was blocked. By implementing this so-called 2 colour method, the potentially residual angular dispersion caused by a small misalignment between the gratings was minimised and estimated to be smaller than 10 μrad/nm.

The compressed pulse was characterized and monitored by using a FROG (frequency resolved optical gating) instrument (also known in a simplified form as Grenouille). The pulse compression was optimised by scanning the incident angle into the compressor and a corresponding grating separation, in conjunction with a Dazzler to compensate residual high order phase due to material dispersion in the system, mainly the terbium gallium garnet crystal (TGG) in the Faraday isolator. The results for the compressed pulse are shown in the graph at the left of FIG. 9. The solid line denotes the measured pulse intensity and the dashed line the measured phase in the time domain. The contrast plot at the right of FIG. 9 is a plot of time delay along the abscissa and wavelength along the ordinate. The different levels of grey represent variations in intensity. The dark grey at the outer parts of the plot represents low intensity, which increases as the grey turns to white. The maximum of intensity occurs at the dark spot in the centre of the plot.

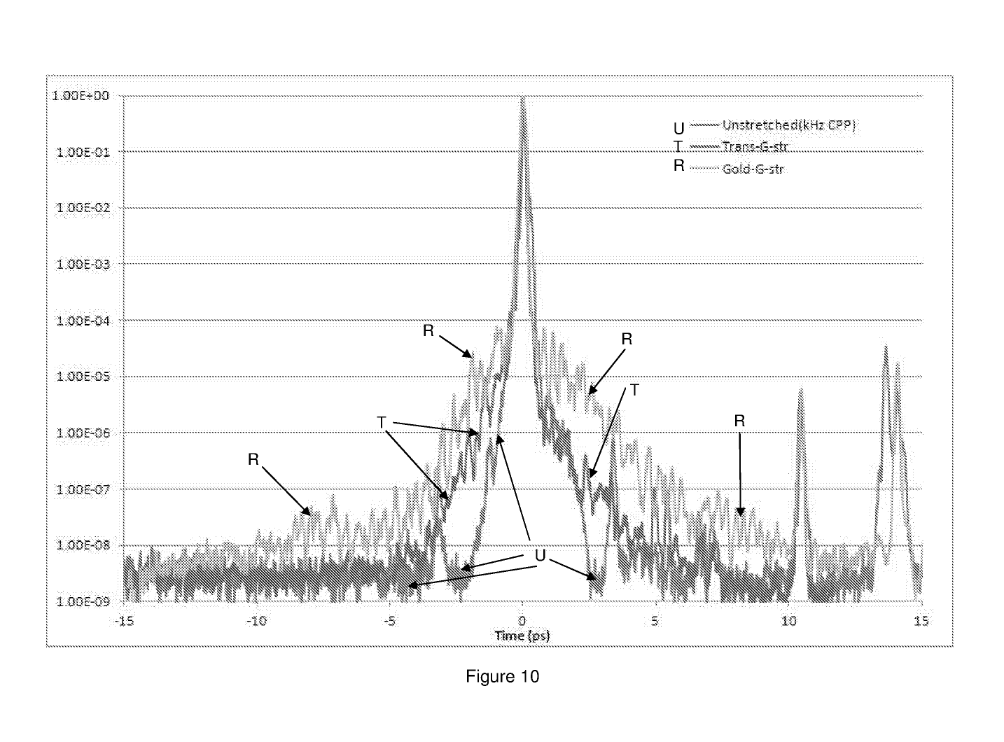

The contrast of the compressed pulse was measured by a third order auto-correlator (Sequoia) measurement. The temporal profile of the stretched and compressed pulse is shown in FIG. 10 as trace “T”.

For comparison the transmission gratings in the stretcher were replaced by conventional reflective gratings having the usual gold coating. This allowed a directly comparable temporal profile to be measured with as close as possible the same stretching and compression factors. The reflective gold gratings used for the experiment had the same groove density as the transmission gratings. The two-colours method was again used to optimise the positions and alignment of the gratings. The stretched pulse was compressed by the same compressor to a near transform limit short pulse of 32 ps. FIG. 10 also shows the temporal profile produced by the reflective gold grating based stretcher. This is shown as trace “R”.

FIG. 10 also shows the profile produced by a single transmission grating in the non-stretching configuration of FIG. 5.

By comparing the temporal profiles using the reflective grating stretcher and transmission grating stretcher in FIG. 10 it is observed that the contrast pedestal induced by the transmission grating stretcher was more than 1-2 orders of magnitude smaller than that of the gold reflective grating stretcher. This leads to a significant improvement in the pulse contrast close to the main peak. This result shows the superior performance of the transmission grating stretcher compared to the conventional reflective gold grating stretcher.

### Investigation

Analysis of the components of the stretcher has revealed that the gold coated gratings are contributors to the contrast pedestal. Limited improvement to the contrast pedestal can be seen by increasing the quality of the grating. The contrast pedestal appears to be at least in part due to spectral phase noise in the dispersed beam. This may be attributed to scattering on the grating surface and spectral phase noise induced by surface roughness and irregularities where the beam is dispersed. SEM (scanning electron microscope) images of reflective diffraction grating substrates show reasonably clean and smooth groove surface structure. For high line density gratings such as used here it appears that it is difficult to place a conformal gold coating onto the periodically structured substrates on a micro or nano-scale. Current coating techniques, for example sputtering, tend to introduce additional surface roughness, resulting in degradation to the surface quality compared to the substrate. In contrast the production of transmission diffraction gratings relies on well-developed photonic fabrication technologies. SEM images of transmission gratings show extremely clean, smooth and precisely defined groove structure, superior to that of gold coated grating structures. Furthermore, no coating is required to be placed on the transmission grating surface eliminating problems caused by the gold coating process. Hence, it is considered that the transmission grating based stretcher provides superior phase noise and contrast pedestal performance because of the better surface characteristics. Transmission diffraction gratings tend to be fused silica.

The stretcher grating which reconverges the paths of the spatially dispersed wavelengths is found to be the more significant contributor to phase noise error. Hence, the most significant reduction in phase noise error is achieved by using a transmission diffraction grating for this grating.

The gratings in the compressor introduce less phase noise error and so it is less important that the compressor uses transmission diffraction gratings. Indeed, conventional metal coated reflective diffraction gratings may be used.

### Further Embodiments

We have described above and shown in FIG. 7 a transmission grating based stretcher. The stretcher of FIG. 7 is derived from the reflective grating stretcher of FIG. 4. Other designs of reflective grating based stretcher exist which may be modified to use transmission diffraction gratings.

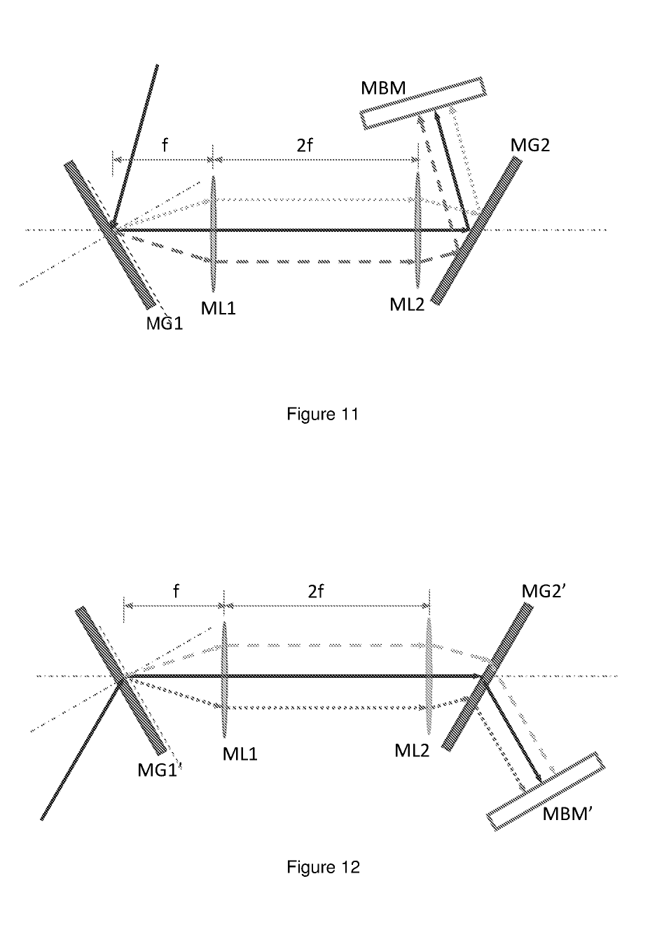

FIG. 11 shows a stretcher design by Martinez et al. which comprises a pair of reflective diffraction gratings MG1 and MG2 and a pair of lenses ML1 and ML2. The two lenses have equal focal lengths and are placed twice the focal length 2f apart in a telescope configuration. The first grating MG1 is placed at the focal distance f in front of lens ML1 and is arranged such that light incident on the grating is diffracted towards the lens ML1. The diffracted light is now spatially distributed by wavelength, is collimated through first lens ML1 and brought into convergence by lens ML2. Before reaching full convergence the light is incident on the second reflective diffraction grating MG2, which is placed closer to lens ML2 than its focal length. The gratings MG1 and MG2 are not aligned parallel, however the image of the first grating MG1 produced by the telescope arrangement of lenses ML1 and ML2 is parallel to the second grating. Upon exiting the second diffraction grating MG2 the paths of the light pulse are parallel such that when incident on back mirror MBM the different wavelength components of the pulse are reflected back along the same path along which they arrived at the back mirror. Stretching of the pulse is achieved by the low frequency components (indicated by the dotted line in FIG. 11) travelling a shorter distance than the high frequency components (indicated by the dashed line in FIG. 11).

FIG. 12 shows a Martinez style stretcher which has been modified to improve contrast pedestal according to the present invention. This has been achieved by replacing the reflective diffraction gratings MG1 and MG2 by transmission diffraction gratings MG1′ and MG2′. The lenses ML1 and ML2 are maintained in their telescope arrangement. The gratings MG1 and MG2 are not parallel. The image of the first grating MG1 generated by the telescope arrangement of lenses ML1 and ML2 is parallel to the second grating. The incident light pulse arrives from behind the grating MG1′, passes through the grating and is diffracted towards first lens ML1. The path through lenses ML1 and ML2 again collimates and then converges the pulse, such that the pulse arrives at the second grating before the pulse fully converges. At the diffraction grating MG2, the light pulse passes through and is diffracted by the grating towards back mirror MBM′. The light leaving the grating MG2′ is collimated such that after reaching back mirror MBM′ it is back reflected along its arrival path. The stretching is again achieved by the shorter path travelled by the high frequency components (denoted by the dotted line in FIG. 12).

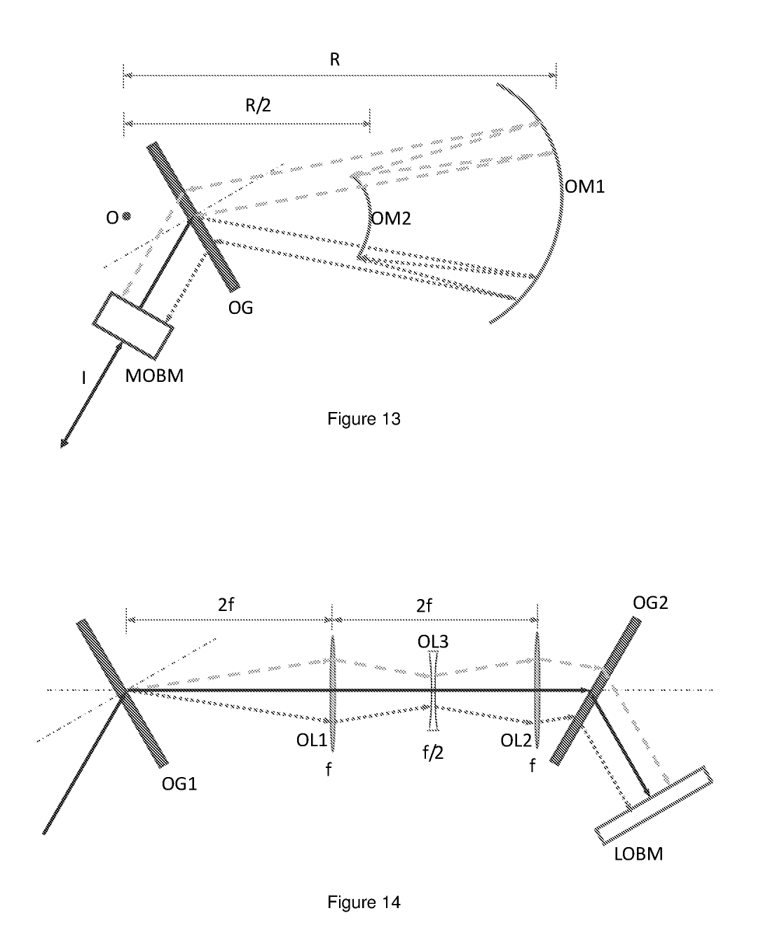

FIGS. 13 and 14 show transmission grating stretcher designs based on reflective diffraction grating stretcher designs by Öffner et al. In the stretchers of FIGS. 13 and 14, the transmission gratings replace reflective gratings of conventional Öffner designs. Lenses and curved mirrors of FIGS. 13 and 14 are largely unchanged from the conventional reflective grating designs, but in both cases the back mirror is located at a different position, on the opposing side of the grating.

FIG. 13 shows the mirror based Öffner stretcher. This comprises transmission diffraction grating OG, a pair of curved mirrors OM1 and OM2, and a back mirror MOBM. Curved mirror OM1 is a concave mirror and curved mirror OM2 is a convex mirror. Mirrors OM1 and OM2 are spherically curved mirrors. OM2 has a radius of curvature half that of OM1, denoted respectively as R/2 and R in FIG. 13. The curved mirrors are arranged such that their radius centres are coincident, as shown at O. Diffraction grating OG is spaced from O towards the mirrors. MOBM may be a back mirror or roof mirror. A roof mirror displaces the beam a small amount but no other changes are required. Incident light pulses I are directed towards grating OG. Alternatively, the incident pulse may arrive at grating OG via a back mirror or roof mirror. Direct arrival at the grating requires the incident beam to arrive out of the plane of the figure. After arrival at grating OG the pulse is transmitted and diffracted as it passes through the grating to disperse the pulse into constituent frequencies which are divergent from the grating. The divergent pulse is reflected by concavely curved mirror OM1 which limits further divergence. The pulse then arrives at convexly curved mirror OM2 and is reflected back towards concavely curved mirror OM1. As the pulse passes from OM1 to OM2 and back to OM1 the pulse diverges only a small amount more than when it arrived at OM1 initially. After reflection from OM1 a second time the components of the pulse are now on a convergent path and are directed towards grating OG. Before reaching convergence, the components reach grating OG and are transmitted and diffracted towards mirror MOBM. The components of the pulse are collimated when they leave OG. From MOBM the path is reversed and the light travels back along the path OG to OM1 to OM2 to OM1 to OG. AS mentioned above, MOBM may be a plane mirror or roof mirror. After passing through OG the pulse is again collimated and is output from the stretcher. In total the pulse passes through grating OG four times and is reflected by concave mirror OM1 four times. The stretching of the pulse arises because of the path length difference occurring between the paths travelled by the low and high frequency components of the pulse. As can be seen in FIG. 13 the low frequency components (represented by dotted lines) travel shorter distance between from curved mirror OM1 to grating OG to back mirror MOBM than the high frequency components (represented by dashed lines). This provides a positively chirped stretched pulse.

FIG. 14 shows a lens based Öffner stretcher. This comprises two transmission gratings OG1 and OG2, two converging lenses OL1 and OL2, a diverging lens OL3 and a back mirror LOBM. The transmission diffraction gratings have substantially identical line density and converging lenses have equal focal lengths f. Converging lens OL1 is at a position twice the focal length from grating OG1 and twice the focal length from converging lens OL2. In between the two converging lenses OL1 and OL2 is diverging lens OL3 which is at the midpoint between, and a distance f from, the converging lenses. Transmission diffraction grating OG2 is at a distance less than the focal length from converging lens OL2. Back mirror LOBM is placed on the opposite side of grating OG2 compared to converging lens OL2. We will now describe the path the light pulse travels through the optical system of this embodiment. The light pulse arrives incident on transmission diffraction grating OG1 and is diffracted and transmitted by the grating. The grating distributes the different frequency components such that they are divergent as they leave the grating. Converging lens OL1 takes the diverging rays and brings them towards convergence. Before the pulse reaches convergence diverging lens OL3 causes them to diverge again towards second converging lens OL2. Second diverging lens brings the components of the pulse towards convergence again, but they reach grating OG2 before they converge to a point. Diffraction grating OG2 transmits and diffracts the pulse such that on exit from the grating the component parts of the pulse are collimated. The collimated pulse arrives at back mirror LOBM normal to the mirror such that the component parts are back reflected along their arrival path. After back reflection the pulse travels through OG2 to OL2 to OL3 to OL1 and back to OG1. At transmission diffraction grating OG1 the pulse components are diffracted from convergent trajectories to provide a collimated stretched output pulse. The diverging lens corrects for aberrations. Stretch of the pulse is provided by the path length difference traversed by the low and high frequency components of the pulse. The low frequency components (represented by dotted line in FIG. 14) travel a shorter path from lens OL2 to grating OG2 to mirror LOBM than the high frequency components (represented by dashed line in FIG. 14). This path length difference is doubled on the return path. The delay caused by the longer path travelled by the high frequency components results in a positively chirped pulse.

The stretchers of FIGS. 12, 13 and 14 all have improved contrast pedestal performance because of the replacement of reflective gold gratings by transmission gratings.

The person skilled in the art will readily appreciate that various modifications and alterations may be made to the above described embodiments without departing from the scope of the appended claims. For example, different configurations of stretcher, such as different arrangements of lenses and mirrors may be used.

1. A pulse stretcher for a chirped pulse amplification laser, the stretcher comprising:
a first diffraction grating arranged to receive and disperse a seed laser pulse;
transfer optics arranged to collect the dispersed pulse and direct it to a transmission diffraction grating which is either the first diffraction grating or a second diffraction grating; and
a reflector, the transmission diffraction grating arranged to collimate the collected pulse to the reflector, and
the reflector arranged such that the pulse is reflected back through the pulse stretcher via the transmission diffraction grating.

2. The pulse stretcher of claim 1, wherein the transmission diffraction grating is arranged such that wavelengths of the pulse arrive at the transmission diffraction grating over successive times with those arriving earlier having a shorter path to travel on to the reflector, thereby providing a chirped pulse.

3. The pulse stretcher of claim 1, wherein the transfer optics are arranged to collect and direct the dispersed pulse so as to bring components of the dispersed pulse onto convergent paths.

4. The pulse stretcher of claim 1, wherein the transmission diffraction grating collimates the pulse normal to the reflector.

5. The pulse stretcher of claim 1, wherein the reflector is a plane mirror.

6. The pulse stretcher of claim 1, wherein the reflector is a roof mirror.

7. The pulse stretcher of claim 1, wherein the reflector is positioned at a side of the transmission diffraction grating opposite from the transfer optics.

8. The pulse stretcher of claim 1, wherein the transfer optics, transmission diffraction grating and reflector are arranged such that for a first wavelength of the laser pulse the path length from transfer optics through transmission diffraction grating to reflector is different to that for a second wavelength of the laser pulse.

9. The pulse stretcher of claim 8, wherein the path length of the first wavelength of the laser pulse from transfer optics through transmission diffraction grating to reflector is greater than the path length of a second wavelength of the laser pulse from the transfer optics through transmission diffraction grating to reflector, wherein the first wavelength is less than the second wavelength, the pulse stretcher thereby imparting a positive chirp to the pulse.

10. The pulse stretcher of claim 9, wherein the path length difference between the path of the first wavelength and the path of the second wavelength is of the order of tens of centimeters.

11. The pulse stretcher of claim 1, wherein the diffraction grating arranged to receive and disperse a seed laser pulse is a first diffraction grating, and the transmission diffraction grating is a second diffraction grating spaced apart from the first diffraction grating.

12. The pulse stretcher of claim 11, wherein the path length from the first diffraction grating to the transfer optics is greater than the path length from the transfer optics to the second diffraction grating.

13. The pulse stretcher claim 11, wherein the distance from the transfer optics to the second diffraction grating is less than the distance from the transfer optics to the first diffraction grating.

14. The pulse stretcher of any of claim 11, wherein the first diffraction grating is a transmission diffraction grating.

15. The pulse stretcher of claim 11, wherein the first diffraction grating has substantially equal line density as the second diffraction grating.

16. The pulse stretcher of claim 11, wherein the reflector is arranged to reverse the path of the pulse such that a pulse having traversed the stretcher firstly in a forward direction subsequently traverses the stretcher in a reverse direction, such that the pulse is incident on each grating in the stretcher twice.

17. The pulse stretcher of any of claim 11, wherein the transfer optics comprises a concavely curved mirror.

18. The pulse stretcher of claim 17, wherein the concavely curved mirror is spherically curved.

19. The pulse stretcher of claim 17, wherein the concavely curved mirror has a radius of curvature R, the first diffraction grating is positioned at a distance greater than or equal to R from the curved mirror and the second diffraction grating is positioned at a distance less than R from the curved mirror.

20. The pulse stretcher of claim 19, wherein the point or line of incidence on the first diffraction grating and the second diffraction grating are arranged on opposing sides of a plane comprising the center of curvature of the curved mirror and the line at which diffracted light is incident on the curved mirror.

21. The pulse stretcher of claim 11, wherein the transfer optics comprises two converging lenses.

22. The pulse stretcher of claim 21, wherein a first of the two lenses is arranged such that its focal plane is at the first diffraction grating, a second of the two lenses is arranged in a telescope arrangement with the first lens and the second lens is at a distance less than the focal length of the second lens from the second diffraction grating.

23. The pulse stretcher of claim 21, wherein the centers of the first and second lenses are spaced apart by the sum of their focal lengths.

24. The pulse stretcher of claim 11, wherein the transfer optics comprises two converging lenses and a diverging lens.

25. The pulse stretcher of claim 24, wherein a first of the two converging lenses is arranged such that its focal plane is at the midpoint between the first diffraction grating and the first converging lens, the centers of the first and second lenses are spaced apart by the sum of their focal lengths, and the diverging lens is at the focal plane of the first and second lenses.

26. The pulse stretcher of claim 1, wherein the transmission diffraction grating is the first diffraction grating and arranged to receive and disperse the seed laser pulse, and said transmission diffraction grating is also arranged to collimate the collected pulse to the reflector.

27. The pulse stretcher of claim 26, wherein the transfer optics comprise a concave mirror and a convex mirror.

28. The pulse stretcher of claim 27, wherein the concave mirror is a spherically curved mirror having a radius of curvature R, the convex mirror is arranged at a distance of R/2 from the concave mirror, and the transmission diffraction grating is arranged at distance less than R from the concave mirror.

29. The pulse stretcher of claim 26, wherein the reflector reverses the path of the pulse such that in combination with the concave and convex mirrors, the pulse traverses the transmission diffraction grating twice in a forward direction and twice in a reverse direction, such that the pulse is incident on the grating in the stretcher four times.

30. The pulse stretcher of claim 1, wherein the stretcher is arranged to stretch the duration of the pulse by a factor of at least 500.

31. The pulse stretcher of claim 1, comprising an input device for directing the laser pulse at the first diffraction grating at the Littrow angle.

32. The pulse stretcher of claim 1, wherein the seed pulses have durations in the order of picoseconds and energy in the order of millijoules.

33. The pulse stretcher of claim 1, further comprising an oscillator for generating seed laser pulses.

34. A pulse stretcher for a chirped pulse amplification laser, the stretcher comprising:
a first diffraction grating arranged to receive and disperse a seed laser pulse;
transfer optics arranged to collect the dispersed pulse and direct it towards a second diffraction grating; and
a reflector, the second diffraction grating arranged to collimate the collected pulse to the reflector, the second diffraction grating being a transmission diffraction grating,
the reflector arranged such that the pulse is reflected back through the pulse stretcher via the second diffraction grating.

35. A pulse stretcher for a chirped pulse amplification laser, the stretcher comprising:
a transmission diffraction grating arranged to receive and disperse a seed laser pulse;
transfer optics arranged to collect the dispersed pulse and direct it back to said transmission diffraction grating; and
a reflector, said transmission diffraction grating further arranged to collimate the collected pulse towards the reflector,
the reflector arranged such that the pulse is reflected back through the pulse stretcher via the transmission diffraction grating.

36. A chirped pulse amplification laser, comprising:
an oscillator for generating seed pulses;
the pulse stretcher of claim 1;
at least one amplifier for increasing the energy of the stretched pulses; and
a pulse compressor for temporally compressing the amplified pulses.

37. The chirped pulse amplification laser of claim 36, wherein the compressor comprises reflective diffraction gratings, and the transmission diffraction grating of the stretcher has an orthogonal polarisation compared to the reflective diffraction gratings of the compressor.

38. The chirped pulse amplification laser of claim 36, wherein the amplified pulses output from the compressor have durations in the order of femtoseconds and peak power in the order of hundreds of terawatts to petawatts.

39. The chirped pulse amplification laser of claim 36, wherein the transmission diffraction grating is uncoated so that spectral phase noise induced by said transmission diffraction grating is less than that of an equivalent reflective metal coated grating thereby improving the contrast pedestal of the output amplified pulse.

40. A method of stretching a laser pulse for a chirped pulse amplification laser, the method comprising:
receiving and dispersing a seed laser pulse using a first diffraction grating;
collecting the dispersed pulse and directing it towards a transmission diffraction grating which is either the first diffraction grating or a second diffraction grating;
the transmission diffraction grating collimating the collected pulse to a reflector,
back reflecting the pulse through the pulse stretcher via the transmission diffraction.
